(19) United States
(12) Patent Application Publication
(10) Pub. No.: US 2026/0008097 A1
(43) Pub. Date: Jan. 8, 2026

(54) MATERIAL AND PROCESS FOR HIGH THROUGHPUT BINDER JET PRINTING OF TITANIUM & PARTICLE REINFORCED TITANIUM ALLOY PARTS

(71) Applicant: Spirit AeroSystems, Inc., Wichita, KS (US)

(72) Inventors: Rahbar Nasserrafi, Wichita, KS (US); Gerald Hicks, Wichita, KS (US); Paul Ray Toivonen, Wichita, KS (US); Daniel Klenosky, Wichita, KS (US)

(21) Appl. No.: 18/763,477

(22) Filed: Jul. 3, 2024

(51) Int. Cl. B22F 1/00; B22F 10/14; B22F 10/22; B22F 10/32; B22F 10/368; B22F 10/64; B33Y 10/00; B33Y 70/00

(52) U.S. Cl. CPC B22F 1/09; B22F 10/14; B22F 10/22; B22F 10/32; B22F 10/368; B22F 10/64; B33Y 10/00; B33Y 70/00; B22F 2201/20; B22F 2203/11; B22F 2301/205

(57) ABSTRACT

Titanium-based alloy powder formulations and methods for use with the powder formulations are disclosed. The formulations and methods disclosed herein enable rapid binder jet manufacturing of large high performance titanium parts.

### BACKGROUND OF THE DISCLOSURE

The present disclosure relates generally to alloy formulations and methods of manufacturing the alloy formulations for use in metal binder jet printing. The alloy formulations are appreciably more tolerant of interstitial element content as compared to conventional titanium alloys as well as include additional and purposeful special micro alloying constituents that can mitigate significant grain growth with sintering temperatures exceeding the beta transus. Additionally, the alloy formulations help to accelerate sintering rate to enable effective binder jet printing of large titanium structures.

Metal binder jet printing technology offers great advantages for manufacturing additively manufactured parts. Metal binder jetting is significantly faster, more economical than other metal additive processes, and can be used for fabricating considerably larger parts. In addition, parts made using this method do not require support structures during printing, allowing more complex shapes to be made.

Main drawbacks of the conventional metal binder jetting process include the mechanical properties of parts made by this method being typically inferior to other metal additive manufacturing processes such as powder bed fusion or direct energy deposition methods. Particularly, sintering titanium with polymer binders results in the formation of pyrolytic carbon. Further, the use of metal powders with their inherent high surface to volume ratios increases pickup of other interstitial elements, such as carbon, nitrogen and oxygen, which has been known to significantly reduce ductility and toughness of conventional titanium alloys used for aircraft structural applications.

In addition, the sintering temperature and times necessary to effectively sinter the powder are conventionally well in excess of beta transus temperature, which can result in excessive grain growth that further degrades mechanical proprieties and performance. And, even with high sintering temperatures, binder jet printing still often results in higher porosity than alternative metal printing processes such as SLM (Selective Laser Melting) and EBM (Electron Beam Melting).

In response to these drawbacks of conventional metal binder jet printing technology, new titanium alloy formulations would be beneficial that could: improve resistance to degradation of mechanical properties due to carbon pickup from organic binders, as well as oxygen and nitrogen pickup due to high surface area per volume of the powder; retard grain growth due to excessive sintering temperatures which are typically well above beta transus; and increase kinetics of diffusion via addition of diffusion aids to generate more effective consolidation/sintering among the powder constituents.

### BRIEF DESCRIPTION

The present disclosure is generally directed to methods and/or powder formulations for use in the methods that enable rapid binder jet manufacturing of large high performance titanium parts. In one embodiment, the present disclosure is directed to a powder formulation including: a titanium alloy; and one or more of: from about 5 to about 19 wt. % tin (Sn); no greater than 5 wt. % aluminum (Al); no greater than 5 wt. % antimony (Sb); and no greater than 2 wt. % bismuth (Bi).

In another embodiment, the present disclosure is directed to a method of metal binder jet printing for forming a metal part. The method including: depositing a powder formulation onto a build platform to form a powder formulation layer, the powder formulation comprising: a titanium alloy; and one or more of: from about 5 to about 19 wt. % tin (Sn); no greater than 5 wt. % aluminum (Al); no greater than 5 wt. % antimony (Sb); and no greater than 2 wt. % bismuth (Bi); depositing binder onto the powder formulation layer to bond the powder formulation layer into a bound layer; and curing of the bound layer to form a metal part.

In yet another embodiment, the present disclosure is directed to a method of metal binder jet printing for forming a metal part. The method including: depositing a powder formulation comprising a titanium alloy onto a build platform to form a powder formulation layer; depositing a binder onto the powder formulation layer to bond the powder formulation layer into a bound layer; curing the bound layer and removing the cured layer from any lose powder formulation; de-binding the cured layer; partially sintering the de-bonded layer; liquid metal infiltrating the partially-sintered metal part with a final composition of one or more of: from about 5 to about 19 wt. % tin (Sn); no greater than 5 wt. % aluminum (Al); no greater than 5 wt. % antimony (Sb); and no greater than 2 wt. % bismuth (Bi); and heat treating the infiltrated partially-sintered metal part for a time period to isothermally solidify the metal part through diffusion of solute elements into the titanium alloy powder resulting in lower localized concentration of solute elements and homogenization of the alloying constituents. In this embodiment, the final composition of the alloy in the metal part is achieved after liquid metal infiltration and subsequent thermal processing including sintering and homogenization.

### BRIEF DESCRIPTION OF THE DRAWINGS

FIG. 1 depicts an exemplary binder jet manufacturing system for use in the methods claimed herein.

FIG. 2 depicts one exemplary method for using the titanium alloy powder formulation of the present disclosure to prepare a metal part.

FIG. 3 depicts one exemplary method for using the titanium alloy powder formulation of the present disclosure to prepare a metal part.

FIG. 4 depicts the effect of the relationship between the amount of aluminum (Al) and the low melting element, tin, on elongation and yield stress as analyzed in Example 4. Using this plot formulation, a composition can be engineered to achieve desired combination of strength and ductility.

FIGS. 5A-5D depict the effect of alloying elements in the power formulation individually and in combination as analyzed in Example 3. FIG. 5A depicts yield stress of the formulations analyzed; FIG. 5B depicts RA of the formulations analyzed; and FIG. 5C depicts UTS of the formulations analyzed. FIG. 5D is a fitted line plot for yield strength that showed R-Squared value of 95.9% as analyzed in Example 3, as demonstrated in FIG. 5A.

FIGS. 6A & 6B depict the impact of carbon levels on ductility of the formulations as analyzed in Example 4. FIG. 6A depicts RA of the formulations as analyzed and FIG. 6B depicts elongation of the formulations as analyzed.

### DETAILED DESCRIPTION

Conventional binder jet printing processes use powder metal and a liquid organic binder (glue) to form a metal additive part. The print head deposits binder onto a layer of metal powder. After each layer is deposited, the object being printed is lowered on its build platform and the process is repeated until the part is fully deposited. The part remains supported within the powder bed and is removed from the unbound powder only once printing has been completed. Following printing, polymer bound powders go through curing, de-powdering, de-binding, sintering, infiltration, heat treating and finishing operations.

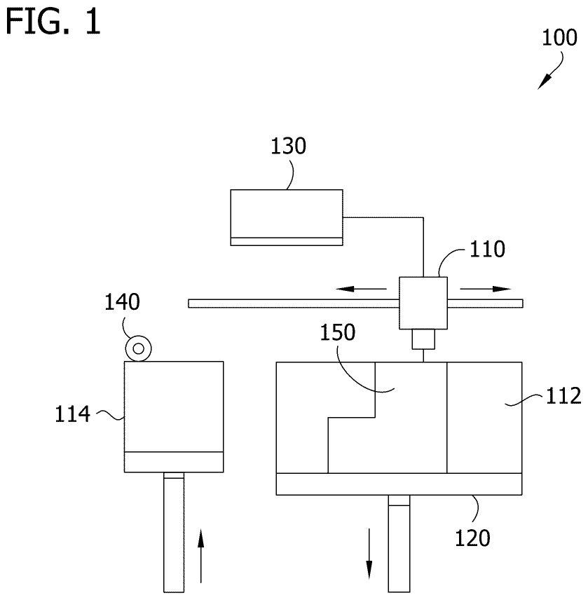

Due to the method of binding and densification, the alloy characteristics of the resultant metal part are not always suitable for stringent structural applications. If not effectively mitigated, this problem can negate the benefits of the process, such as the rapid speed of printing, and the complexity of the parts that can be made by this process. FIG. 1 depicts the conventional metal binder jet manufacturing system and printing process. Conventional processes typically use stainless steel. Table 1 provides a comparison of strength and elongation for Binder Jet Printed vs. SLM 316 L Stainless Steel.

TABLE 1

| | Binder Jet 316 | Binder Jet 316L | DMSL/SLM |
|---|---|---|---|
| | Stainless | Stainless Bronze | Stainless |
| Typical Values | Steel-Sintered | infiltrated | Steel 316L |
| Yield Strength | 31 ksi | 41 ksi | 62 ksi |
| Elongation at Break | 34% | 14.50% | 40% |

### Powder Formulations

The present disclosure is directed to titanium alloy-based powder formulations for use in metal binder jet printing processes that allow for appreciably more tolerance of interstitial element content as compared to conventional titanium alloys, as well as allow for purposeful addition of special micro alloying constituents that can mitigate significant grain growth with sintering temperatures that exceed the beta transus. Further, the formulations of the present disclosure allow for accelerated sintering rates of the method to enable effective binder jet printing of large titanium structures.

Generally, the present disclosure is directed to near alpha titanium matrix alloy formulations with less than 2.5% beta stabilizing element (e.g., molybdenum or molybdenum equivalent) as described herein and small amounts of carbides (i.e., up to 0.4% by weight carbon content). As used herein, “near alpha titanium” refers to alpha-beta titanium alloys that are lean in beta stabilizing elements. These alloys are often used for applications requiring higher temperature capabilities than conventional alpha-beta alloys that contain higher levels of beta stabilizing elements, and beta titanium alloys. In addition, near alpha titanium alloys are also preferred for cryogenic applications. Near alpha titanium alloys possess higher beta transus temperature as compared to both beta-rich alpha-beta titanium alloys and beta titanium alloys. Particularly, it has been found that the specific formulations result in near alpha titanium alloys possessing higher temperature capability and alpha-beta or beta titanium matrices, that can also function better than their beta containing alloy counterparts as the hexagonal close-packed (HCP) alpha lattice is more resistant to cryogenic conditions than the BCC beta phase.

Suitably, the titanium matrix alloy formulations including from about 75 wt. % to about 85 wt. % titanium.

Additionally, the instant titanium alloy-containing powder formulation as described in the present disclosure allows incorporation of strengthening elements in the form of low melting elements (LMEs) as a solder of low temperature bonding or sealing agents. These elements melt and bond well below the temperature that titanium begins to react with atmosphere to form embrittling phases. Particularly, the inclusion of low melting elements renders the alloy formulation more tolerant of interstitial elements, especially carbon, enabling binder jet printing of high temperature near alpha alloys that are not embrittled due to diffusion of carbon remnants from the organic binder into the titanium matrix. Thus, higher low melting element (LME) levels, as well as higher tin levels, in the formulation allow for more interstitial element strengthening as compared to standard aluminum rich near alpha alloys.

Carbon levels exceeding solubility levels in titanium can be used which result in formation of small/controlled amounts of metallic carbides (MC) (e.g. TiC, NbC, TaC). The presence of TiC within the titanium matrix that can further strengthen the matrix.

In one embodiment, the titanium-based alloy powder formulation includes a titanium alloy and one or more of the following: from about 5 to about 19 wt. % tin (Sn), suitably, from about 5 to about 15 wt. %; no greater than 5 wt. % aluminum (Al), suitably, from about 2 to about 4.5 wt. %; no greater than 5 wt. % antimony (Sb); and no greater than 2 wt. % bismuth (Bi). Suitably, when used in the formulation, the sum of Sn, Sb and Bi is no greater than 20 wt. %. It has been found herein, that alloys exceeding the amounts of Sn, Sb and Bi stated herein will result in significant reduction in toughness and ductility. Alloys with higher amounts of Sn, Sb, and Bi could also potentially cause metallurgical instability and embrittlement of the resulting metal part. Although inclusion of controlled amounts of low melting elements improve tolerance towards interstitial pickup, exceeding the limits stated herein could result in loss of ductility and toughness.

In some embodiments, the powder formulation can further include: from about 0.05 wt. % to about 0.25 wt. % oxygen (O); from about 0.1 wt. % to about 0.4 wt. % carbon (C); and no greater than 0.03 wt. %. nitrogen (N). Typically, the sum of C, O, and N in the powder formulation is no greater than 0.45 wt. % so as to prevent the reduction in ductility and toughness in the resulting metal parts.

In some embodiment, the powder formulation of the present disclosure further includes a beta stabilizing element for increasing strength. Further, some beta stabilizing elements, such as niobium (Nb), tantalum (Ta), and molybdenum (Mo), also greatly improve oxidation resistance and hot corrosion resistance, thereby allowing the alloy to be used at higher application temperatures. Suitable beta stabilizing elements include molybdenum (Mo), vanadium (V), chromium (Cr), iron (Fe), manganese (Mn), or any combination thereof. In one embodiment, the formulation can include from about 1 to about 3 wt. % of any one or more of these beta stabilizing elements. In another embodiment, the beta stabilizing element is niobium (Nb) and the formulation can include from about 1 to about 6 wt. % of the beta stabilizing element.

In yet other suitable embodiments, the powder formulation can include one or more highly reactive element such as erbium (Er), yttrium (Y), gallium (Ga), and germanium (Ge). Other suitable elements include hafnium (Hf) and scandium (Sc). In addition, small silicon (Si) additions can promote precipitation of silicides, which further enhance elevated temperature strength and creep resistance. It has been found that inclusion of the highly reactive elements allows for the formation of very small oxide particles; thereby reducing dissolved oxygen in the titanium alloy matrix. This would further increase the amount of carbon that can effectively be included in the alloy formulation & retards grain growth. Suitably, the formulations can include highly reactive elements in amounts of from about 0.02 to about 0.12 wt. %.

It has been found herein, that using these powder formulations for manufacturing metal parts as discussed above, the impact of aluminum, low melting elements, oxygen and carbon on strength is statistically significant, whereas the impact of carbon levels on ductility is statistically insignificant; thereby reducing embrittling effects of pyrolithic carbon from the binder jet binder and allowing further strengthening by purposeful addition of carbon.

### Methods of Using Powder Formulations

The present disclosure is further directed to methods of preparing metal parts using the titanium alloy-containing powder formulations described above. For example, in one suitable embodiment, the titanium alloy-containing powder formulations include near alpha titanium matrix alloy formulations with less than 2.5% beta stabilizing elements and small amounts of carbides (e.g., e.g. TiC, NbC, TaC). In other suitable embodiments, the powder formulations include the titanium-alloy with one or more low melting elements (LMEs), one or more beta stabilizing element, and/or one or more highly reactive element in the amounts as described above. It has been found that the alloy formulation and the processes of using the formulation allow fabrication of metal parts of high strength without appreciable loss in ductility. Further, the presence of controlled levels of carbides and reactive microalloying constituents help minimize grain growth during sintering operations by providing grain boundary drag by copious distribution of finely dispersed insoluble carbides or in-situ formed oxides of Y, Er or Ge.

In one suitable embodiment, the manufacturing processes of the present disclosure use the powder formulation as discussed above in a traditional de-binding/binder burnout, vacuum sintering/consolidation and heat treatment inkjet printing method. For example, the process initially includes depositing the powder formulation as described herein onto a build platform to form a powder formulation layer. Any suitable method of depositing the powder formulation to a build platform to form a powder formulation layer can be used herein. Once a layer is deposited, a binder, typically a liquid polymeric binder, is deposited onto the powder formulation layer to bond the powder formulation layer into a bound layer. For example, liquid binder can be selectively deposited in the form of fine droplets to bond the powder particles and achieve good resolution. Any suitable method of depositing liquid binder to the powder formulation layer can be used in the methods of the present disclosure. In some embodiments, the low melting elements (LMEs) as described herein are included with the liquid binder to be deposited on the titanium-alloy powder formulation. Typically, these low melting elements are jetted or deposited in the form of solder in-lieu of polymer binder to bond the metal powder. In this embodiment, the final chemistry of the metal part is then formed after the sintering and heat treating described below as the solute elements diffuse into the powder.

Typically, the powder formulation layer to which liquid binder is applied has a thickness of from about 50 to about 250 micrometers. The steps of layering the powder formulation and depositing binder onto the powder formulation layer can be repeated until the desired metal part is formed.

As shown in FIG. 1, an inkjet printhead 110 is used to deposit droplets of liquid binder 130. Typically, from about 0.001″ to about 0.003″ of binder is deposited onto each powder formulation layer to bond the powder formulation into a bound layer. In one suitable embodiment, the binder is deposited onto the powder formulation layer in a ratio of binder to powder formulation layer of from about 1:4 to about 1:8. After each layer is deposited, build platform 120 moves downwards and another layer of powder formulation is deposited, followed by deposition of binder. In some embodiments, a powder roller 140 distributes new powder from a new powder stock 114 uniformly over the build platform 120 and allows deposition of binder from the inkjet printhead 110 onto a powder bed 112 to form the desired layer shape. After the first layer is printed, new powder is uniformly distributed over the previous printed powder layer by a powder roller 140 to allow deposition of binder from the printhead 110 onto the powder bed 112 to form the layer shape, and the process is repeated and a part 150 is built three dimensionally, layer by layer until the part geometry is fully formed within the powder bed.

The process further provides for curing of the bound layers (also referred herein as powder bed) to form a metal part. Curing of the bound layers is typically performed under ambient pressure at 200° F. to 600° F. for a time period of from about 1 to about 5 hours to solidify and harden the formed metal part and allow effective de-powdering and handling of the part for subsequent processing. For most applications, oven curing is performed at a temperature of from between about 350° F. and about 450° F. In some embodiments, additional post-cure processing will be performed to form the metal part. Post-cure processing includes de-binding; vacuum sintering; and heat treating to form the metal part. Typically, debinding is the first step and is conducted to remove excess binder from the formed metal part. Depending on the specific binder being used, this may be done via degradation and/or evaporation. The processes of degradation and evaporation may be conducted as readily determined by those skilled in the art.

After debinding, the metal part can be sintered. Sintering is the process of densification, where diffusion of particle surfaces take place and metal parts begin to bind together, closing off the voids where the binder previously was. The part shrinks between 15-20% (linearly). There are 3 main stages of sintering: presintering, intermediate sintering, and final sintering. Typically, vacuum sintering can be used with the methods of the present disclosure.

During presintering, necks begin to form between powder particles, mass transport occurs from the near neck region to the neck region. In titanium, this occurs between 1200° and 1650° F. During presintering there is little to no shrinkage.

The next process is intermediate sintering. During intermediate sintering, the necks continue to grow while the pores shrink, eventually becoming round. Densification occurs, and by the end of the intermediate stage, parts are generally approximately 92% dense.

Lastly, during the final stage of sintering, pores continue to shrink, and the part further densifies. To optimize part density, sintering temperatures and holds are closely monitored to control and avoid grain growth, which can occur if parts are left at elevated temperatures. The alloy formulation allows final sintering temperatures to be performed well above beta transus, for example up to 2000° F. in order to achieve more effective densification, up to 98% without hot isostatic pressing (HIP), and 100% of the theoretical density when HIP is used to achieve full densification.

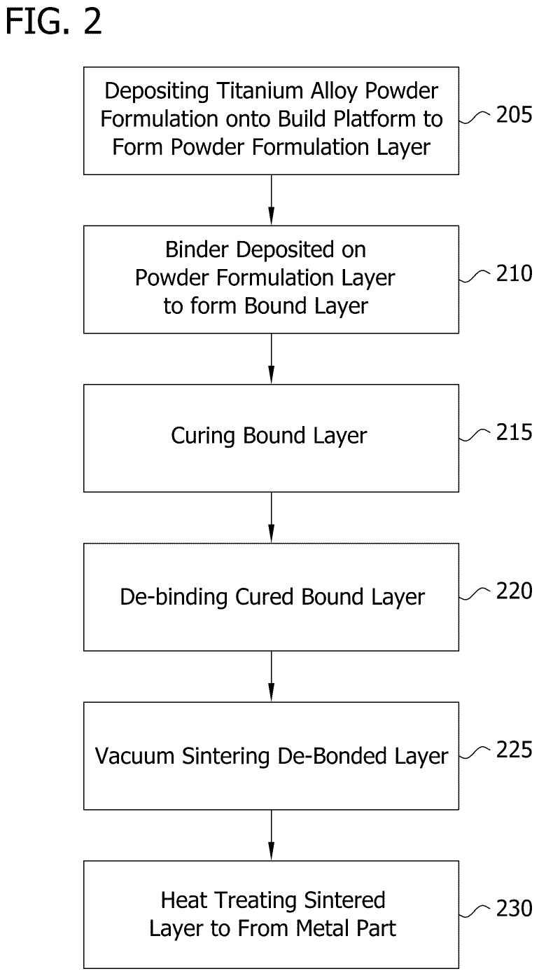

FIG. 2 depicts one exemplary method using the system 100 described in FIG. 1 for preparing a metal part using the titanium alloy-containing powder formulations. Initially, in step 205, titanium alloy powder formulation is deposited onto build platform to form a powder formulation layer. In step 210, binder, and in suitable embodiments, liquid binder, is deposited onto the powder formulation layer to form a bound layer. The process is repeated until the entire part geometry is 3-D printed. The bound layers are then cured in step 215. The cured bound layer is de-binded 220 using methods as described above. The de-bounded layer is then vacuum sintered 225 and heated treated 230 to form a metal part.

It should be understood that using the above described embodiment for the method of making the metal part, as the cured bound layer is already in its final composition (except for some carbon pickup from the organic binder), much more rapid ramp rates can be employed. The metal part can be heated at rates of about 200° F. to about 1000° F. per hour to the sintering temperature, which the powders fully sinter and bond together to form effective metallurgical bonds between the adjoining powders and to ensure that complete isothermal solidification by sufficient diffusion among the atoms by lowering of the localized concentration of solute (lower melting) elements, and held at that temperature for about 8 to about 24 hours for sintering & homogenization. Sintering/diffusion bonding temperature is typically achieved between 1600° F. and 1800° F. However, the alloy formulation allows vacuum sintering to about 2000° F.

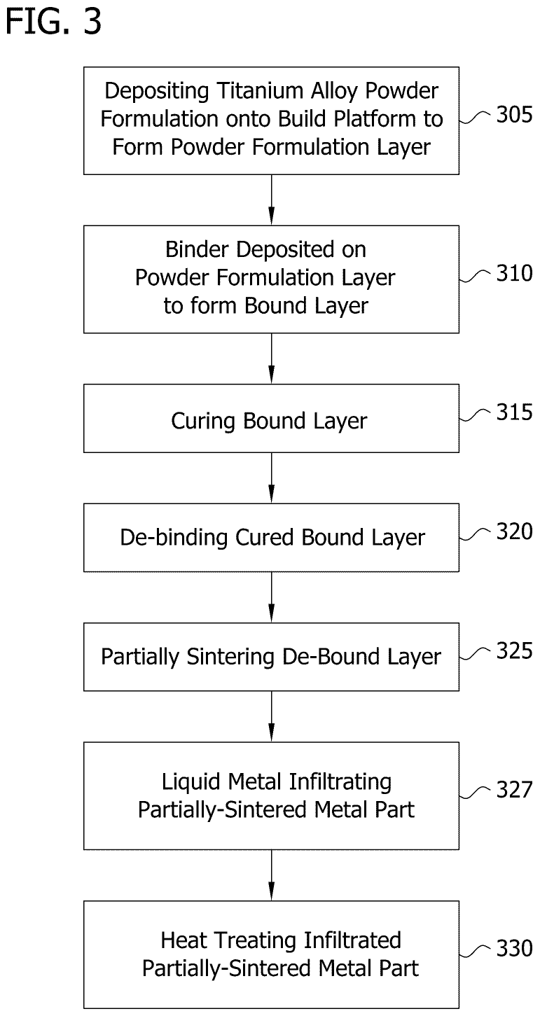

Alternatively, the present disclosure is directed to use of the titanium alloy in a non-conventional method for forming the metal part. In this embodiment, as discussed in FIG. 3, the powder formulation including titanium alloy is deposited onto the build platform 305 to form a powder formulation layer, and binder, in particular, liquid binder is deposited onto the powder formulation layer to bond the powder formulation layer into a bound layer as indicated at 310. In this embodiment, the process includes depositing binder onto the powder formulation layer in a ratio of binder to powder formulation layer of from about 1:4 to about 1:8. These steps are again repeated until the powder bed in the form of the desired metal part is formed.

The bound layer is then cured 315 and any loose powder formulation is removed. The cured layer can then be de-binded 320 and partially sintered 325 using the methods as described above. As used herein, “partial sintered” or “partial sintering” refers to sintering the de-bonded part to allow solid state (diffusion) bonding of the metallic particles to produce a stable (strong enough) structure for the subsequent molten metal infiltration described herein, but where the sintering time is insufficient for full densification of the part structure. That is, partial sintering imparts sufficient strength and structural stability to the metal part while the part still contains interconnected porosity to allowing impregnation of liquid metal into the open cavities. For reference, an un-sintered part is typically 40% to 60% theoretical density, the remaining part being connected pores. Partial sintering might increase density to no more than 70% providing a stable part structure while still maintaining interconnected pores where the low melting elements can infiltrate into. On the other hand, full sintering will result in 95% to 100% of the theoretical density.

In suitable embodiments, the cured layer that is to be partially sintered is sealed such as with a ceramic or glass coating. The sealing will allow all alloy constituents to be retained during sintering/homogenization step via inter-diffusion of the low melting solute elements into the titanium alloy matrix (i.e., partially sintered) structure.

Once partially sintered, the partially-sintered metal part is infiltrated with a liquid metal composition as indicated at step 327. Suitably, in one embodiment, the liquid metal infiltration composition includes the low melting elements (LMEs) as described herein. For example, in one embodiment, the composition of the processed metal part includes one or more of the following: from about 5 to about 19 wt. % tin (Sn); no greater than 5 wt. % aluminum (Al); no greater than 5 wt. % antimony (Sb); and no greater than 2 wt. % bismuth (Bi). In this embodiment, the partially-sintered part is made from powder formulation containing no or low levels of low melting elements, and the final alloy chemistry for the part is reached when low melting elements are infiltrated into the partially-sintered metal part. Holding at that temperature, followed by ramping to the sintering/homogenization temperature and holding until full isothermal solidification has been achieved by inter-diffusion of the solute elements.

It has been found that the processes and formulations developed synergize to enable rapid binder jet manufacturing of large high performance titanium parts. Binder jet printing of titanium-alloy powders using low melting alloying elements in lieu of using organic binders to bind the particles together is made possible by the fact that tin, bismuth, antimony, alone or combined, melt well below the temperature at which titanium reacts excessively with oxygen (under 850° F.) and, when solidified, will act as binding agents for the powder metal. The low melting binder, once solidified, will bind the alloy powder together in its pre-sintered form. Subsequent sintering results in diffusion of the binder into the alloy powder, isothermal solidification and development of the final alloy chemistry.

Furthermore, the infiltrated partially-sintered metal part suitably has a ramp rate of from about 50° F./hour to about 1000° F./hour. Ramp rate refers to degrees increase per unit of time (e.g., hours), and refers to the time at temperature. The ramp rate depends on the section and part configuration. The idea is to be able to heat the entire part uniformly so that both thin and thick sections and inside and outside features can heat up uniformly. Thin parts with uniform cross section can be heated up and cooled faster. Finite element modeling can be used to determine optimum ramp rates. For the instant method embodiment, ramp rate for infiltrating partially sintered metal parts can range from 50° F. per hour to 1000° F. per hour depending on part geometry, and it is determined by the ability to achieve temperature uniformity (+/−25° F.) when the part reaches infiltration temperature. Ramp rate is best determined using final element modeling (FEM) of the part in question. Low melting alloys being infiltrated typically melt below 700° F., and part temperature at infiltration is typically between 600° F. and 850° F. Hold times to complete infiltration for this embodiment ranges from 30 minutes to 4 hours at infiltration temperature followed by slow ramp at 50° F. per hour to 150° F. per hour to final sintering temperature that can range from 1600° F. to 1800° F. Final sintering, when desired, can be performed at temperatures above 2000 F to improve densification, especially when the part is not hot isostatically pressed (HIP).

The metal part is finally fully sintered or homogenized (i.e., heat treating the infiltrated partially-sintered metal part 330) to solidify the metal part. After final sintering temperature is reached, the metal part is maintained at the temperature to allow sufficient time at the desired temperature to achieve adequate homogenization of the chemical composition of the metal part.

When desired, HIP can be performed at from about 15000 psi to about 35000 psi at approximately 1500° F. to 1750° F. to achieve complete densification.

The part can be solution treated at approximately 1600° F. to 1750° F. for about 1 to about 4 hours, inert gas fan cooled to room temperature and aged (precipitation hardened at approximately 900° F. to 1200° F. for about 4 to about 8 hours to further improve its mechanical properties.

In some embodiments, prior to sintering/heat treatment, the metal part is covered with a protective layer. Typically, the protective layer includes a ceramic or glass plate as is conventionally known in the art.

When introducing elements of the present invention or the various embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above processes without departing from the scope of the invention, it is intended that all matter contained in the above description and shown in the accompanying drawing[s] shall be interpreted as illustrative and not in a limiting sense.

The present disclosure will be further described in the following non-limiting Examples.

### EXAMPLES

### Example 1

In this Example, various powder formulations were prepared. The formulations are shown in Table 2 as follows:

TABLE 2

| | Molybdenum/ | Low Melting | | Other Beta | Highly | |
|---|---|---|---|---|---|---|
| Near-alpha | molybdenum | Element | Carbon/Oxygen/ | Stabilizing | Reactive | Other Trace |
| Titanium | substitute | (LME) | Nitrogen | Element | Element | Element |
| Component of | Component in | Component(s) | Components in | Component(s) | Component(s) | Component(s) |
| Alloy | Alloy | in Alloy | Alloy | in Alloy | in Alloy | in Alloy |
| Formulation | Formulation | Formulation | Formulation | Formulation | Formulation | Formulation |
| ~80 wt. % | — | Sn 15 | O 0.15 | Nb 5 wt. % | Si 0.1 | <0.30 |
| | | wt. % | wt. % | | wt. % | wt. % |
| | | | C 0.15 wt. % | | Sc 0.05 | |
| | | | | | wt. % | |
| | | | | | Er 0.10 | |
| | | | | | wt. % | |
| ~77 wt. % | Mo 1.5 | Sn 15 | O 0.15 | Nb 5 wt. % | Si 0.1 | <0.30 |
| | wt. % | wt. % | wt. % | | wt. % | wt. % |
| | | | C 0.15 wt. % | | Y 0.04 | |
| | | | | | wt. % | |
| | | | | | Er 0.08 | |
| | | | | | wt. % | |
| ~80 wt. % | Mo 1.5 | Sn 12 | O 0.15 | Nb 3 wt. % | Ge 0.06 | <0.30 |
| | wt. % | wt. % | wt. % | | wt. % | wt. % |
| | | Al 2 wt. % | C 0.15 wt. % | | | |
| ~82 wt. % | Mo 0.5 | Sn 12 | O 0.10 | Nb 3 wt. % | Er 0.08 | <0.30 |
| | wt. % | wt. % | wt. % | | wt. % | wt. % |
| | | Al 2 wt. % | C 0.25 wt. % | | | |
| ~84 wt. % | Mo 0.5 | Sn 9 wt. % | O 0.10 | Nb 3 wt. % | Gd 0.08 | <0.30 |
| | wt. % | Sb 2 wt. % | wt. % | | wt. % | wt. % |
| | | Al 1 wt. % | C 0.35 wt. % | | | |
| ~81 wt. % | Mo 0.5 | Sn 15 | C 0.20 wt. % | Nb 3 wt. % | Er 0.12 | <0.30 |
| | wt. % | wt. % | | | wt. % | wt. % |

### Example 2

In this Example, the relationship between the amount of aluminum (Al) and the low melting element, tin, on elongation and yield stress (YS) is analyzed. YS and elongation are measured by tensile testing using the standard method of ASTM-E8.

Contour Plots (Minitab Software) were used to demonstrate the combination of aluminum and LME levels for the best combination of strength and ductility levels. In this case, when carbon is 0.08% and oxygen is about 0.19%. Similar analysis was performed for other oxygen and carbon levels.

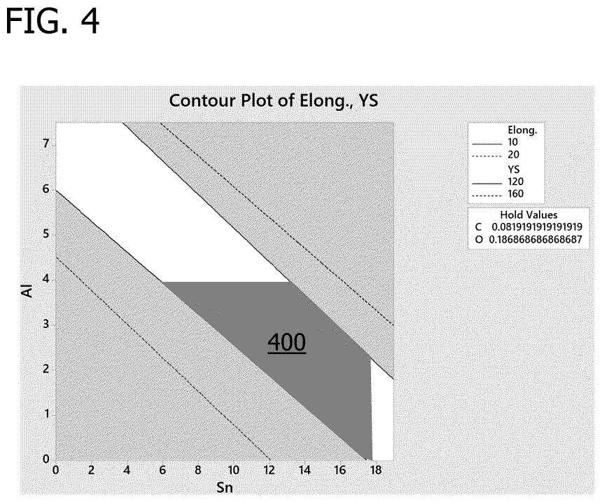

The results are show in FIG. 4. A blue contour line 402 indicates the aluminum and LME effects at 10% elongation, while a blue dotted contour line 404 indicates the aluminum and LME effects at 20% elongation. Moreover, a red contour line 412 indicates the aluminum and LME that can result in 120 ksi yield strength and a red dotted contour line 414 indicates the aluminum and LME that can result in 160 ksi yield strength. The particularly suitable amounts of Al to tin are in shaded box 400. As shown, the shaded box 400 shows the aluminum and LME that can result in 120 ksi minimum yield strength with minimum 10% elongation. Moreover,

### Example 3

In this Example, the effect of alloying elements in the power formulation individually and in combination were analyzed using ASTM-E8.

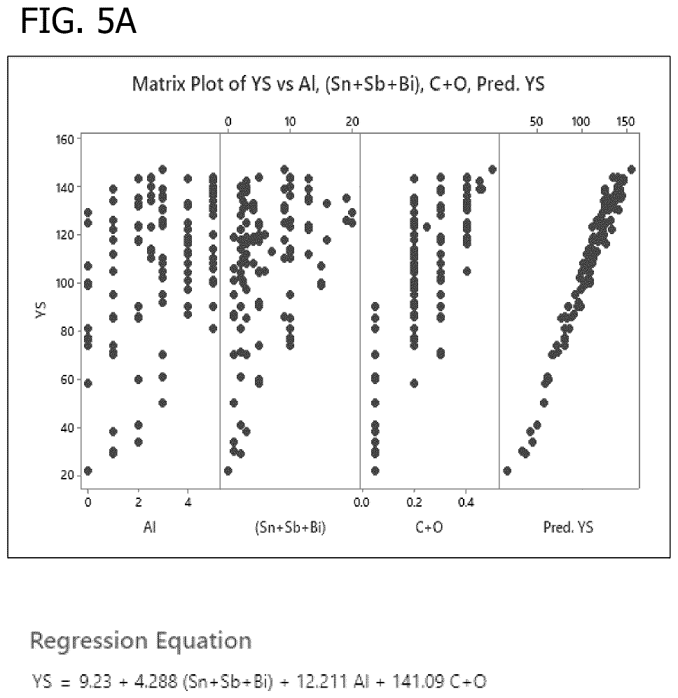

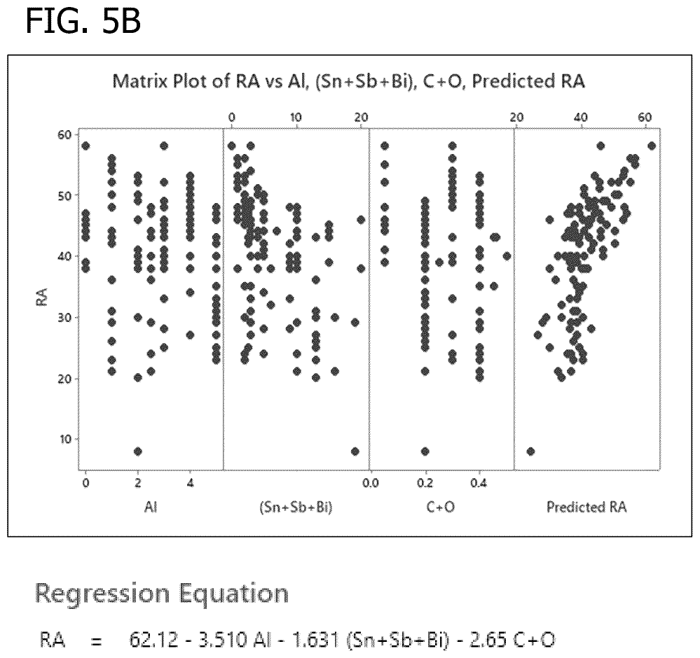

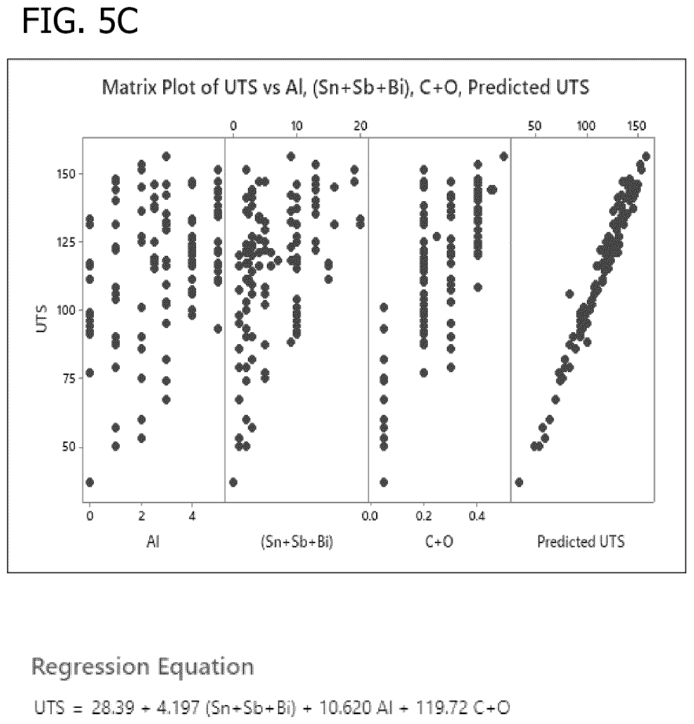

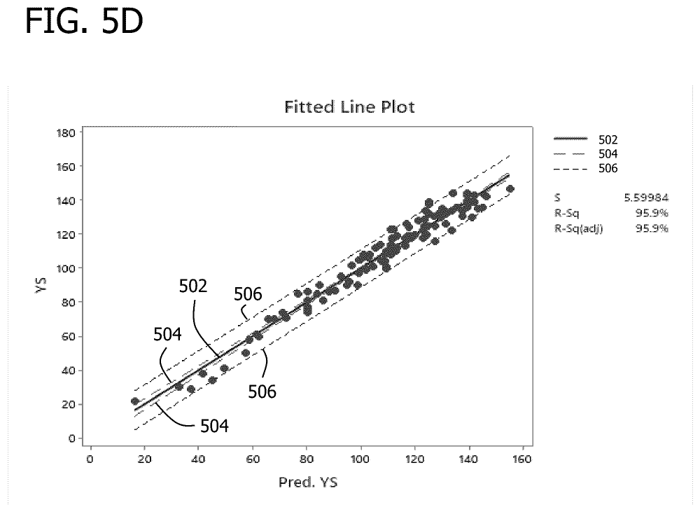

Particularly, powder formulations including the following components were prepared: (Sn+Sb+Bi)=<20%; Sn=5% to 18%, preferably 8% to 15%; Sb=0% to 10% (preferably up to 5%) and Bi=0% to 2%; Al=0% to 4.5%, preferably 2-4%; <0.05% Oxygen <0.25%; 0.08<Carbon <0.35%; Nitrogen <0.03%; (C+O+N)<0.45%; and 0.02% to 0.12% highly reactive elements to remove interstitial elements by forming stable oxides and nitrides. The effects of the alloying elements on yield stress, RA and UTS are shown in FIGS. 5A-5C.

Particularly, FIG. 5A shows the individual and combined effects of Al, (Sn+Sb+Bi), and (C+O) content on Yield Strength (YS). The formula is derived using multiple regression analysis of the yield strength versus the input variables. Having the formula allows prediction of yield strength as the function of alloying elements.

Further, FIG. 5B shows that percent reduction of area does not greatly change between zero and 0.4% C+O. At the same time strength is significantly increased when C+O are increased up to 0.4% as seen in FIG. 5A and FIG. 5C.

The results of the analysis show that there is very high fidelity between the predicted and actual yield strengths. Further, as shown in the fitted line plot for YS in FIG. 5D, R-Squared had a value of 95.9%, which indicates that over 95% of the variation in yield strength can be attributed to the chemistry using the prediction formula. As shown in FIG. 5D, a red contour line 502 indicates line of regression. A green contour line 504 indicates the 95% confidence interval and a purple dotted contour line 506 indicates the 95% prediction interval.

Reduction of area (RA) is determined by comparing the width and thickness of the tensile specimen before and after tensile testing since, when the specimen is elongated, its width and thickness are reduced as the gage volume remains the same.

Ultimate tensile strength (UTS) is a measure of the load that can be applied to a material before it fails. The tensile strength of a material is measured using a tensile testing machine which applies a pulling load to a test specimen until it breaks. The rate of elongation and load of the force applied can be used to calculate the material properties.

One other important observation is that the correlation between individual elements, for example Al, Sn, C, etc., on yield strength is not nearly as when they are combined in the fashion described by the matrix plot and the prediction formula, as there is significant interaction between the individual alloying elements (see the spread in UTS data for Al, (Sn+Sb+Bi), (C+O) versus the spread as determined by the prediction formula (FIG. 3C).

### Example 4

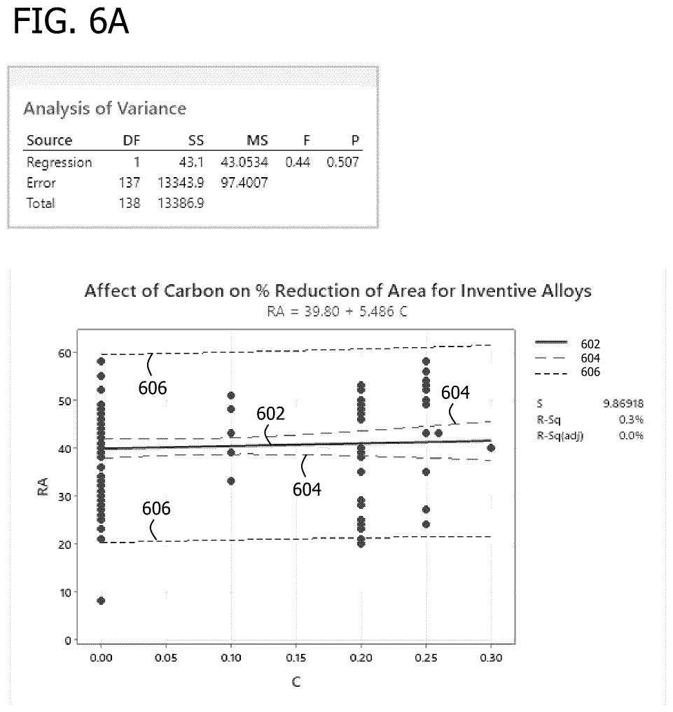

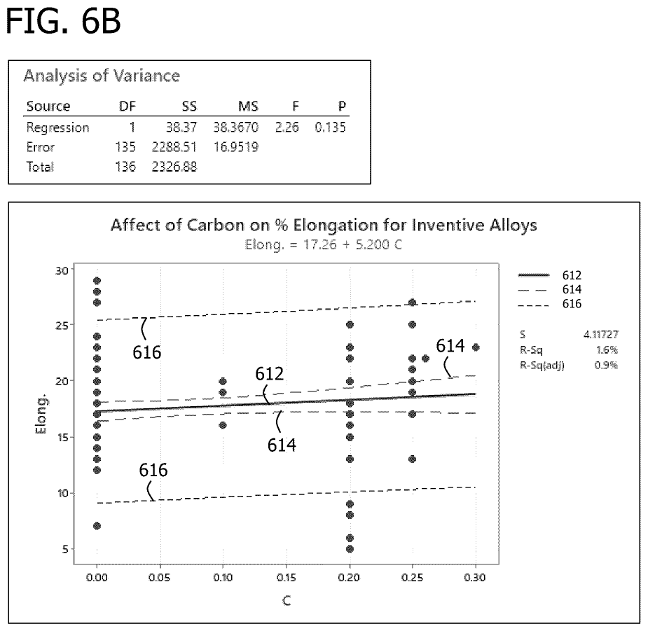

In this Example, the impact of carbon level on ductility of the powder formulations is analyzed for reduction of area (RA) and elongation. The results are shown in FIGS. 6A and 6B.

ASTM-E8 is the method for determining elongation & reduction of area (RA). Tensile testing per ASTM-E8 applies axial force to a test specimen at specified strain rates and the specimen is stretched due to the application of axial load. The deformation (stretching) is initially elastic only which means the part specimen will return to its original dimensions if the load was to be removed. But, beyond a certain load, the deformation will be permanent and the specimen will no longer return to its original shape. The level of both elastic and permanent deformation is determined/recorded by attaching an extensimeter to the gage length of the specimen. Elongation (permanent) can also be measured by measuring the gage length after testing is completed using dial calipers.

FIGS. 6A and 6B, with their associated statistics (P-Values) being much above the 0.05 threshold, show no statistically significant impact on carbon level (an interstitial element) up to 0.3% on elongation and reduction of area. As shown in FIGS. 6A & 6B, a red contour line 602 and 612, respectively, indicates line of regression. A green contour line 604 and 614 indicates 95% confidence interval and a purple dotted contour line 606 and 616 indicates 95% prediction interval.

Tolerance in this context means that if the upper limit for carbon for conventional alloys is exceeded, for example, 0.08% carbon for Ti-6-4 and for Ti-6-2-4-2, good ductility can be achieved (better than 15% reduction of area). That is, the results indicate that within the formulations proposed the effects of carbon level on % Elongation and % RA are not statistically significant since P-Values are above 0.05. In other words, adding carbon up to 0.3% by weight does not affect elongation nor reduction in area which is an important discovery since carbon addition can greatly increase strength. In conventional titanium alloys, carbon is kept below 0.08% as it is believed to cause embrittlement. But, by controlling Al and low melting elements (i.e., less aluminum and more tin, bismuth or antimony), further strengthening with carbon without significant reduction in ductility can be achieved. As the impact of carbon on elongation and reduction of area is not statistically significant with the compositions of the present disclosure, the inventive alloy compositions can suitably be used for binder jet printing of titanium alloys which contain pyrolithic carbon.

### Example 5

In this Example, the effect of higher tin (Sn) content as compared to aluminum (Al) content in the powder formulations was analyzed.

What is claimed is:

1. A powder formulation comprising:
a titanium alloy; and
one or more of:
from about 5 wt. % to about 19 wt. % tin (Sn);
no greater than 5 wt. % aluminum (Al);
no greater than 5 wt. % antimony (Sb); and
no greater than 2 wt. % bismuth (Bi).

2. The powder formulation of claim 1 further comprising:
from about 0.05 wt. % to about 0.25 wt. % oxygen (O);
from about 0.1 wt. % to about 0.4 wt. % carbon (C);
not greater than 0.03 wt. %. nitrogen (N).

3. The powder formulation of claim 2
wherein the sum of C, O, and N, is no greater than 0.45 wt. %.

4. The powder formulation of claim 1, wherein the sum of Sn, Sb and Bi is no greater than 20 wt. %.

5. The powder formulation of claim 1 further comprising a beta stabilizing element selected from the group consisting of molybdenum (Mo), vanadium (V), chromium (Cr), iron (Fe), manganese (Mn), niobium (Nb) or any combination thereof.

6. The powder formulation of claim 1 further comprising one or more highly reactive element selected from the group consisting of Erbium (Er), yttrium (Y), gallium (Ga), germanium (Ge), and scandium (Sc).

7. A method of metal binder jet printing for forming a metal part, the method comprising:
depositing a powder formulation onto a build platform to form a powder formulation layer, the powder formulation comprising:
a titanium alloy; and
one or more of:
from about 5 to about 19 wt. % tin (Sn);
no greater than 5 wt. % aluminum (Al);
no greater than 5 wt. % antimony (Sb); and
no greater than 2 wt. % bismuth (Bi);
depositing binder onto the powder formulation layer to bond the powder formulation layer into a bound layer; and
curing of the bound layer to form a metal part.

8. The method of claim 7, wherein the powder formulation further comprises a beta stabilizing element is selected from the group consisting of molybdenum (Mo), vanadium (V), chromium (Cr), niobium (Nb), iron (Fe), manganese (Mn), or any combination thereof.

9. The method of claim 7, wherein the powder formulation comprises one or more highly reactive element selected from the group consisting of erbium (Er), yttrium (Y), gallium (Ga), germanium (Ge), and scandium (Sc).

10. The method of claim 7, comprising repeating the steps of depositing the powder formulation onto the build platform and depositing binder onto the powder formulation layer to bond the powder formulation to provide a powder stack, each powder formulation deposited will independently have a thickness of from about 50 to about 250 micrometers.

11. The method of claim 7 comprising depositing from about 0.001″ to about 0.003″ binder onto the powder formulation.

12. The method of claim 7 further comprising one or more of the following:
de-binding the bound layer;
vacuum sintering the de-bonded layer; and
heat treating the layer to form the metal part.

13. A method of metal binder jet printing for forming a metal part, the method comprising:
depositing a powder formulation comprising a titanium alloy onto a build platform to form a powder formulation layer;
depositing a binder onto the powder formulation layer to bond the powder formulation layer into a bound layer;
curing the bound layer and removing the cured layer from any lose powder formulation;
de-binding the cured layer;
partially sintering the de-bonded layer;
liquid metal infiltrating the partially-sintered metal part with a composition of one or more of:
from about 5 wt. % to about 19 wt. % tin (Sn);
no greater than 5 wt. % aluminum (Al);
no greater than 5 wt. % antimony (Sb); and
no greater than 2 wt. % bismuth (Bi); and
heat treating the infiltrated partially-sintered metal part for a time period to solidify the metal part.

14. The method of claim 13, wherein the surface of the infiltrated partially-sintered metal part is covered with a protective layer prior to heating, wherein the protective layer comprises ceramic or glass.

15. The method of claim 13, wherein the infiltrated partially-sintered metal part has a ramp rate of from about 50° F./hour to about 1000° F./hour.

16. The method of claim 13, where the infiltrated partially-sintered metal part has a hold time of from about 30 minutes to about 4 hours at infiltration temperature.

17. The method of claim 13, where the temperature of the infiltrating liquid metal is below 850° F.

18. The method of claim 13, wherein the powder formulation comprises a beta stabilizing element selected from the group consisting of molybdenum (Mo), vanadium (V), chromium (Cr), niobium (Nb), iron (Fe), manganese (Mn), or any combination thereof.

19. The method of claim 13, wherein the powder formulation further comprises one or more highly reactive element selected from the group consisting of Erbium (Er), yttrium (Y), gallium (Ga), germanium (Ge), and scandium (Sc).

20. The method of claim 13, wherein the binder is a composition of one or more of:
from about 5 to about 19 wt. % tin (Sn);
no greater than 5 wt. % aluminum (Al);
no greater than 5 wt. % antimony (Sb); and
no greater than 2 wt. % bismuth (Bi).
